(19) United States
(12) Patent Application Publication
(10) Pub. No.: US 2002/0025986 A1
(43) Pub. Date: Feb. 28, 2002

(54) Formulation

(76) Inventors: David Kirk Rodham, Bracknell (GB); Guy Ramsay, Bracknell (GB); David Joseph Brown, Bracknell (GB); Tharwat Fouad Tadros, Bracknell (GB)

Correspondence Address: Edward D. Grieff, Esq., Hale and Dorr LLP, Suite 1000, 1455 Pennsylvania Avenue, N.W., Washington, DC, 20004, US

(21) Appl. No.: 09/836,468

(22) Filed: Apr. 18, 2001

(30) Foreign Application Priority Data
Apr. 19, 2000 (GB) 0009735.2

(51) Int. Cl. C09K 3/00

(52) U.S. Cl. 516/98

(57) ABSTRACT

A water-in-oil-in-water multiple emulsion comprises a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets and at least one of (a) the inner dispersion of aqueous phase droplets and (b) the oil phase droplets being encapsulated within a polymer wall material.

This invention relates to a formulation and in particular to a encapsulated water-in-oil-in-water multiple emulsion.

Water-in-oil-in-water multiple emulsions are known and consist of a continuous aqueous phase having dispersed therein oil phase droplets wherein the oil phase droplets themselves each contain dispersed “inner” aqueous phase droplets. Hitherto such multiple emulsions have been of theoretical interest but have found only limited commercial applicability. In particular, water-in-oil-in-water multiple emulsions are often difficult to stabilise, especially where electrolytes are dissolved in either of the aqueous phases as these phases have to be osmotically balanced. Also known are encapsulated single emulsion formulations wherein the dispersed phase droplets are encapsulated within a polymer wall. Such encapsulated emulsions have wide commercial applicability, for example as slow-release formulations or to provide a polymer barrier to reduce physical contact between a user of the emulsion and the encapsulated material. In general encapsulated emulsions are formulated with an aqueous continuous phase and a dispersed encapsulated oil phase and for this reason are more suitable for oil-soluble active materials than water-soluble active materials.

An encapsulated water-in-oil-in-water multiple emulsion is novel and provides advantages for the formulation of water-soluble or water dispersible active materials.

Thus according to the present invention there is provided a water-in-oil-in-water multiple emulsion comprising a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets and at least one of (a) the inner dispersion of aqueous phase droplets and (b) the oil phase droplets being encapsulated within a polymer wall material.

According to a further aspect of the present invention there is provided a method of preparing a water-in-oil-in-water multiple emulsion comprising a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets and at least one of (a) the inner dispersion of aqueous phase droplets and (b) the oil phase droplets being encapsulated within a polymer wall material, which method comprises

i) forming a water-in-oil emulsion in which an aqueous solution or dispersion of the active material is emulsified in an oil phase containing a predominantly oil-soluble polymer precursor and emulsifying the water-in-oil emulsion into an aqueous phase containing a predominantly water-soluble polymer precursor such that interfacial polymerisation takes place to form a polymer wall encapsulating the dispersed oil droplets; or

ii) forming a water-in-oil emulsion in which an aqueous solution or dispersion of the active material is emulsified in an oil phase containing a first predominantly water-soluble polymer precursor, adding a predominantly oil-soluble polymer precursor whereby the polymer precursors undergo interfacial polymerisation to microencapsulate the dispersed aqueous droplets and thereafter emulsifying the resultant encapsulated water-in-oil emulsion into an aqueous phase; or

iii) forming a water-in-oil emulsion in which an aqueous solution or dispersion of the active material is emulsified in an oil phase containing a first predominantly water-soluble polymer precursor, adding a predominantly oil-soluble polymer precursor whereby the polymer precursors undergo interfacial polymerisation to microencapsulate the dispersed aqueous droplets and thereafter emulsifying the resultant encapsulated water-in-oil emulsion into an aqueous phase containing a second predominantly water-soluble polymer precursor, optionally with the addition of further oil-soluble polymer precursor, such that further interfacial polymerisation takes place to form a polymer wall encapsulating the dispersed oil droplets; or

iv) forming a water-in-oil-in-water emulsion comprising a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets wherein the oil phase contains a first oil-soluble polymer precursor and a second oil-soluble polymer precursor which together form a polymer material when heated in the presence of water and heating the emulsion to form a polymer at the oil-water interfaces.

It is to be understood that the term “active material” as used herein is not to be restricted to a material showing biological activity but includes any material which performs a useful technical function and which it is desired to present in the form of a water-in-oil-in-water multiple emulsion. The active material can reside in any or all of the three phases. It is to be further understood that the multiple emulsions according to the invention can comprise polymer capsule walls at either or both of the internal water/oil and external oil/water interfaces.

Preferably the polymer wall material is formed by the reaction or interaction of two or more polymer precursor materials.

The nature of the water-soluble active material is not critical, since the present invention can be used to provide slow-release characteristics or to provide a protective polymer wall for any desired water-soluble active material. Suitable water-soluble active materials may be found in many technical fields but the present invention is primarily exemplified in the context of a water-soluble pharmaceutically active material or a water-soluble agrochemical or public health material, including without limitation herbicides, fungicides, insecticides and nematicides.

Water-in-oil-in-water multiple emulsions may be formed by a variety of techniques but it is generally convenient first to form a water-in-oil emulsion stabilised by a suitable surfactant system and then to emulsify the water-in-oil emulsion into a continuous aqueous phase using the same or preferably a different surfactant system. A wide variety of surfactants suitable for forming and stabilising such emulsions are commercially available and the emulsion may be formed by conventional low or high-shear mixers or homogenisation systems, depending on particle size requirements. Typical techniques for forming stable water-in-oil-in-water multiple emulsions are described for example in EP 0276911. The choice of surfactant, and in particular the surfactant used in the primary emulsion, is important in the establishment of stable interfaces. Polymeric surfactants are especially preferred for stabilising the primary, internal water-in-oil emulsion. Advantageously such polymeric surfactants may be capable of stabilising the internal phase both by their surface activity and by their ability to produce viscoelastic films at the water-oil interface.

Especially preferred polymeric surfactants used to form the initial water-in-oil emulsion include those described at column 5, line 26 to column 6, line 10 of U.S. Pat. No. 4,244,816. As specific examples of suitable surfactants there may be mentioned:

(a) An ABA block co-polymer of poly-12-hydroxystearic acid and polyethylene oxide. Such co-polymers are described in, for example, published UK patent Application No. 2002400. A copolymer of this kind is commercially available under the trade name ATLOX 4912(ATLOX is a trademark);

(b) The reaction product of polyisobutylenesuccinic anhydride (PIBSA) and ethanolamine, described in UK patent application 2156799. A further example of a primary emulsifier is a related polymer which has been reacted with one mole of phosphoric acid to yield a monophosphate derivative (as described in Example 5 of UK patent application 2156799).

(c) Other examples of suitable primary emulsifiers include the following: sorbitan monooleate (SPAN 80—SPAN is a trademark), sorbitan trioleate (SPAN 85), mixtures of SPAN 80 with TWEEN 80 (sorbitan monolaurate condensed with 20 molar proportions of ethylene oxide—TWEEN is a trademark), TWEEN 85 (sorbitan trioleate condensed with 20 molar proportions of ethylene oxide), Lecitthin (phosphatidyl choline), SPAN 80/Lecithin mixtures, sorbitan sesquioleate (ARLACEL 83—ARLACEL is a trademark) optionally mixed with lecithin, polyoxyethylene sorbitol hexa-oleate (G-1086) and polyethylene imines such as SOLSPERSE 17000 (SOLSPERSE is a trademark.

The surfactant used to disperse the water-in-oil emulsion into the aqueous phase to form the water-in-oil-in-water multiple emulsion, the secondary emulsifier, may selected from a broad list of emulsifiers capable of forming oil-in-water emulsions well known to those skilled in the art. Examples include:

a) condensates of alkyl (eg octyl, nonyl or polyaryl) phenols with ethylene oxide and optionally propylene oxide and anionic derivatives thereof such as the corresponding ether sulphates, ether carboxylates and phosphate esters;

block copolymers of polyethylene oxide and polypropylene oxide such as the series of surfactants commercially available under the trademark PLURONIC (PLURONIC is a trademark of BASF);

b) TWEEN surfactants, a series of emulsifiers comprising a range of sorbitan esters condensed with various molar proportions of ethylene oxide;

c) condensates of C₈ to C₃₀ alkanols with from 2 to 80 molar proportions of ethylene oxide and optionally propylene oxide; and

d) polyvinyl alcohols, including the carboxylated and sulphonated products.

Mixtures of surfactants may be used to form either the primary or secondary emulsifier. If desired stability may additionally be increased by the formation of a gel within the oil phase or surrounding the oil phase droplets. The formation of a gel may for example be desirable to enhance the stability of a singly encapsulated multiple emulsion in which a polymer wall protects the inner aqueous phase droplets only. Suitable gelling agents will occur to those skilled in the art and a typical example is polymethacrylic acid in the presence of aluminium ion as described for example in EP 0276911. If desired an outer phase thickening agent may be used to increase the viscosity. A typical thickening agent is a polysaccharide. If the thickening agent is susceptible to biological degredation, a biocide may also be added. Protective colloids such as a lignosulphonate may be used in the outer phase and may also act as a secondary emulsifier.

It will be understood that the primary surfactant used to produce the precursor emulsions prior to encapsulation will also act to stabilise the internal water-in-oil droplets in the multiple emulsion. As has been noted above, previously known water-in-oil-in water multiple emulsions are often difficult to stabilise, especially where electrolytes are dissolved in either of the aqueous phases, as these phases have to be osmotically balanced. It is an advantage of the formulations of the present invention that the presence of polymer walls at the water/oil or oil/water interfaces generally improves stability such that the choice of surfactant becomes less critical and furthermore the need for balancing of osmotic pressure is reduced. It is to be understood however in some instances, for example if a high concentration of active ingredient which is an electrolyte is used in he inner aqueous phase, it may still be desirable to balance osmotic pressure to prevent rupture of the polymer walls. Osmotic pressure is conveniently balanced by the addition of a salt such as magnesium chloride to the outer aqueous phase. Where a salt is used to balance osmotic pressure, we have found that problems of flocculation previously encountered in such systems may be significantly reduced.

Preferably the polymer wall is formed by the reaction of two or more polymer precursors. Many such polymer precursors are known and one skilled in the art is able to select suitable polymer precursors and reaction conditions (such as the degree of cross-linking) to provide a polymer wall thickness and durability ranging from relatively transient polymer walls which can readily be disrupted to relatively durable polymer walls which provide slow release over a considerable period of time. Polymer precursors are also known which provide a polymer wall material which is degraded by external factors. Thus for example once an agrochemical formulation is diluted into water for application onto a target crop, the polymer wall material may be disrupted by the change in osmotic pressure within the encapsulated droplets or for example may be degraded under the action of sunlight.

One class of polymer precursors consists of a primarily oil-soluble component and a primarily water-soluble component which react together to undergo interfacial polymerisation at a water/oil interface. Typical of such precursors are an oil-soluble isocyanate such as toluene diisocyanate and a water-soluble amine such as diethylenetriamine to ensure crosslinking takes place. Cross linking variation may be achieved by increasing the functionality of the amine. Thus for example, cross-linking is increased if ethylene diamine for example is replaced by a polyfunctional amine such as DETA (Diethylene triamine), TEPA (Tetraethylene pentamine), AEP (Aminoethylpiperazine), and other well established cross linking amines. Isocyanate functionality can be altered (and thus cross-linking also altered) by moving from monomeric isocyanates such as toluene diisocyanate to PAPI (Poly(methylene) poly(phenyl) isocyanate). Mixtures of isocyanates, for example mixtures of toluene diisocyanate and PAPI, may also be used. Moreover, solubility can be altered by varying the chemistry from aromatic isocyanates to aliphatic isocyanates such as hexamethylenediisocyanate and isophorone diisocyanate. Further modifications can be achieved by partially reacting the isocyanate with a polyol to produce an amount of a polyurethane within the isocyanate chemistry to induce different properties to the wall chemistry. One skilled in the art will be aware of many other chemistries available for the production of a polymeric wall about an emulsion droplet. As well as the established isocyanate/amine reaction to produce a polyurea wall chemistry, there can be employed improvements to this technology including for example that in which hydrolysis of the isocyanate is allowed to occur to an amine which can then further react internally to produce the polyurea chemistry (as described for example in U.S. Pat. No. 4,285,720). Variation in the degree of cross linking may be achieved by altering the ratio of monomeric isocyanate to polymeric isocyanate. As with the conventional isocyanate technology described above, any alternative isocyanates can be employed in this embodiment.

Other chemistries which may be employed in the present invention for the production of the polymer wall include polyurethane chemistry whereby an isocyanate is allowed to react with an alcohol (or polyol) to produce the polyurethane. Polyhydric alcohols such as glycerol, pentaerythritol, sugars can be employed as well as polyvinylalcohol. Mixtures of polyurea and polyurethane can be produced. Polyamides can be produced by reaction of an acid chloride with an amine or polyesters by reaction of an acid chloride with an alcohol, and again, mixtures of wall chemistries can be achieved. Newer aminoplast chemistries can also be employed in one aspect of this invention as described for example in U.S. Pat. No. 4,956,129 and U.S. Pat. No. 5,332,584. Coacervate chemistries can also be employed to good effect for these formulations. Many techniques of producing a coacervate are known. Such techniques include gelatin/gum arabic systems and the synthetic ion pairing effects of polymeric anionic/cationic systems.

Thus in one embodiment of the present invention a water-in-oil emulsion is first formed wherein an aqueous solution of the desired active material is emulsified in an oil phase containing a predominantly oil-soluble polymer precursor such as toluene diisocyanate and thereafter the water-in-oil emulsion is itself emulsified into an aqueous phase containing a predominantly water-soluble polymer precursor such as diethylenetriamine such that interfacial polymerisation takes place to form a polymer wall encapsulating the dispersed oil droplets.

Thus according to a further aspect of the present invention there is provided a water-in-oil-in-water multiple emulsion comprising a continuous aqueous phase having dispersed therein oil phase droplets wherein each oil phase droplet contains an inner dispersion of aqueous phase droplets, a water-soluble active material being dissolved in the inner dispersion of aqueous phase droplets and the oil phase droplets being encapsulated within a polymer wall material formed by interfacial polymerisation of a predominantly water-soluble polymer precursor dissolved in the continuous aqueous phase and a predominantly oil-soluble polymer precursor dissolved in the oil phase droplets.

In a further embodiment of the present invention an encapsulated water-in-oil emulsion is first formed wherein an aqueous solution of the desired active material containing a first predominantly water-soluble polymer precursor such as diethylenetriamine is emulsified in an oil phase. After the emulsion has been formed, a predominantly oil-soluble polymer precursor such as toluene diisocyanate is added, whereby the polymer precursors undergo interfacial polymerisation to microencapsulate the dispersed aqueous droplets and thereafter the encapsulated water-in-oil emulsion is itself emulsified into an aqueous phase containing a second predominantly water-soluble polymer precursor such that interfacial polymerisation takes place to form a polymer wall encapsulating the dispersed oil droplets. The first predominantly water-soluble polymer precursor and the second predominantly water-soluble polymer precursor may be the same or different. Sufficient of the predominantly oil-soluble polymer precursor may be added in the first stage such that excess is present after the microencapsulation of the inner aqueous phase or alternatively additional predominantly oil-soluble polymer precursor may be added prior to the second stage in which microencapsulation of the oil phase droplets takes place.

Thus according to a further aspect of the present invention there is provided a water-in-oil-in-water multiple emulsion comprising a continuous aqueous phase having dispersed therein oil phase droplets wherein each oil phase droplet contains an inner dispersion of aqueous phase droplets, a water-soluble active material being dissolved in the inner dispersion of aqueous phase droplets, the inner aqueous phase droplets being encapsulated within a polymer wall material formed by interfacial polymerisation of a first predominantly water-soluble polymer precursor dissolved in the inner aqueous phase and a predominantly oil-soluble polymer precursor dissolved in the oil phase droplets and the oil phase droplets being encapsulated within a polymer wall material formed by interfacial polymerisation of a second predominantly water-soluble polymer precursor dissolved in the continuous aqueous phase and the predominantly oil-soluble polymer precursor dissolved in the oil phase droplets.

It is thus preferred that polymer wall material is the product of the reaction between an oil-soluble isocyanate and an water-soluble isocyanate-reactive polymer precursor wherein

i) the oil phase droplets are encapsulated within a polymer wall material formed by interfacial polymerisation of the oil-soluble isocyanate dissolved in the oil phase droplets and the isocyanate-reactive polymer precursor dissolved in the continuous aqueous phase or

ii) the inner aqueous phase droplets are encapsulated within a polymer wall material formed by interfacial polymerisation of a first isocyanate-reactive polymer precursor dissolved in the inner aqueous phase and the oil-soluble isocyanate dissolved in the oil phase droplets and the oil phase droplets are further encapsulated within a polymer wall material formed by interfacial polymerisation of a second isocyanate-reactive polymer precursor dissolved in the continuous aqueous phase and the oil-soluble isocyanate dissolved in the oil phase droplets.

Alternatively again, the encapsulated water-in-oil emulsion formed in the first stage of the above process may (ii) be dispersed in an aqueous phase without further microencapsulation to form a water-in-oil-in-water multiple emulsion comprising a continuous aqueous phase having dispersed therein oil phase droplets wherein each oil phase droplet contains an inner dispersion of aqueous phase droplets having a water-soluble active material dissolved therein wherein the inner water phase droplets are encapsulated within a polymer wall material formed by interfacial polymerisation of a predominantly water-soluble polymer precursor dissolved in the inner aqueous phase and the predominantly oil-soluble polymer precursor dissolved in the oil phase droplets.

Alternatively again, the encapsulated water in oil emulsion can be further diluted with suitable emulsifiers and solvents to give an encapsulated water-in-oil emulsion which on dilution with water forms a water-in-oil-in-water emulsion of the present invention.

A further class of polymer precursors consists of two precursor components which form a polymer material when heated. Typical of such a system is a polymer precursor which is an isocyanate such as toluene diisocyanate and a cross-linking material such as [polymethylene](polyphenylisocyanate) which initiates polymerisation on heating in the presence of water. Such heat-initiated precursors are typically both dissolved in the oil phase and form a polymer at the oil/water interface when heated. Thus the two precursor components may be dissolved in the oil phase of a water-in-oil-in-water multiple emulsion and heated, whereupon polymerisation will occur at both the interface of the oil droplets and the continuous aqueous phase and at the interface of the internal aqueous droplets dispersed within the oil droplets. The polymer wall thickness of the inner encapsulated aqueous droplets relative to that of the encapsulated oil droplets will depend on a number of factors including the relative interfacial surface areas. It will be appreciated that the use of heat-initiated polymerisation has the advantage of providing polymerisation at both interfaces in a single step but lacks the flexibility of a two stage process such as that described above in which the durability of the polymer wall encapsulating the inner aqueous droplets and that encapsulating the organic phase droplets may be independently controlled. Moreover, the need to work with emulsions which remain stable during the heating process places further constraints on this system and the reaction cannot be selectively controlled at each interface.

In one variation therefore both the inner aqueous phase droplets and the oil phase droplets are encapsulated within a polymer wall material which is the product of heating an oil-soluble isocyanate and an oil-soluble cross-linking agent in the presence of interfacial water. Preferably the oil-soluble isocyanate is toluene diisocyanate and the oil-soluble cross-linking agent is [polymethylene](polyphenylisocyanate).

A wide variety of materials suitable for use as the oil phase will occur to one skilled in the art. Examples include, diesel oil, isoparaffin, aromatic solvents, particularly alkyl substituted benzenes such as xylene or propyl benzene fractions, and mixed napthalene and alkyl napthalene fractions; mineral oils, white oil, castor oil, sunflower oil, kerosene, dialkyl amides of fatty acids, particularly the dimethyl armides of fatty acids such as caprylic acid; chlorinated aliphatic and aromatic hydrocarbons such as 1,1,1-trichloroethane and chlorobenzene, esters of glycol derivatives, such as the acetate of the n-butyl, ethyl, or methyl ether of diethylene glycol, the acetate of the methyl ether of dipropylene glycol, ketones such as isophorone and trimethylcyclohexanone (dihydroisophorone) and the acetate products such as hexyl, or heptyl acetate. The preferred organic liquids are xylene, diesel oil, isoparaffins and alkyl substituted benzenes.

It is also possible to use a liquid active ingredient as the oil phase without further dilution by solvent. As examples of suitable liquid active ingredients which may form the oil phase there may be mentioned a liquid ester of the herbicide 2,4-D and liquid esters of the herbicide fluazifop or fluazifop-P.

In some instances we have found that the rate of release of the active material may be significantly affected by the nature of the oil phase. Moreover, we have found that the oil phase can also exert an adjuvancy effect, increasing the bioefficacy of the active ingredient contained within the formulations. Suitable examples of oils that can exert an adjuvant effect as well as forming the oil phase in the water-in-oil emulsion include mineral oils, paraffin oils, diesel oils, vegetable oils and especially the esterified vegetable oils such as methyl oleate or methyl rapate.

The overall loading of the water-soluble active material, the phase volume of the inner aqueous phase and the phase volume of the water-in-oil emulsion in the continuous water phase may all be varied to suit the particular application under consideration. Examples in the agrochemical field are illustrated below.

In some instances, for example if the water-soluble active material is an electrolyte, osmotic pressure variation may develop as between the inner dispersed aqueous phase and the continuous aqueous phase as a result of diffusion of material through the polymer wall(s). If the water-in-oil-in-water multiple emulsion is designed to be diluted in water prior to use, any such effect will be exacerbated on dilution. In this case, it may be desirable to increase the electrolyte content of the continuous aqueous phase in order to balance the osmotic potential between the electrolytic water soluble active material in the inner dispersed aqueous phase and the electrolyte in the outer continuous aqueous phase. Many suitable water-soluble electrolytes will occur to one skilled in the art. Examples include inorganic salts such as magnesium chloride or its hydrates.

It will be appreciated that the present invention provides an inner dispersed aqueous phase containing the water-soluble active material and a distinct aqueous continuous phase separated therefrom by the polymer wall(s). It is possible therefore to include a second water-soluble active material in the continuous phase. Such second active material may be a material which is incompatible with the first material in aqueous solution, for example a second agrochemical or an agrochemical adjuvant which is incompatible with the active material contained in the inner aqueous dispersed phase. Alternatively, it may be desirable to include a second active material in the continuous aqueous phase to provide a rapid action which is subsequently followed by a slow-release effect of the encapsulated material in the inner dispersed aqueous phase. Indeed, it would be possible to have the same active material in both the continuous aqueous phase and the inner dispersed aqueous phase if it is desired to achieve both a rapid action and a sustained release effect.

It will be appreciated that it is possible to have an active ingredient or different active ingredients in all the three phases of the multiple emulsion (the internal aqueous phase, the middle oil phase and the external aqueous phase). As noted above, a liquid active ingredient may even itself form the oil phase or may be dissolved in the oil phase. Moreover, the active may be presented in solution (in either the oil or aqueous phases) or as a dispersion of solid material in any of the phases where different controlled release effects are desired.

Whilst the scope of the present invention is not limited to any one particular class of active materials, the invention is particularly suitable for the manufacture of slow-release formulations of water-soluble herbicides such as fomesafen, glyphosate and more particularly for the presentation of the herbicide paraquat in a encapsulated water-in-oil-in-water multiple emulsion formulation which minimises physical contact between the user and the active material and which reduces the adverse effects of deliberate or accidental ingestion. As an example of a water-in-oil-in-water multiple emulsion formulation where it is desired to provide for sequential treatment of a first agrochemical contained in the continuous aqueous phase followed by a second agrochemical whose released is delayed by the microencapsulation, there may be mentioned the treatment of plants with glyphosate and fomesafen. Mixtures of glyphosate and fomesafen are found to be antagonistic when formulated together whereas such antagonism may be substantially alleviated by formulation of glyphosate in the continuous aqueous phase and fomesafen in the encapsulated internal aqueous phase.

The pesticide can be introduced into any of the three phases depending on it's physical properties. If the pesticide has relatively low solubility in water, with a melting point above 55° C., it can be formulated as a dispersion of solid in water, which can be incorporated into either or both of the aqueous phases. The invention is particularly applicable to pesticides having a solubility in water of not more than 600 ppm, more particularly not more than 150 ppm, and most particularly not more than 50 ppm. The invention is also particularly applicable to pesticides having a melting point of at least 55° C., more particularly at least 77° C., and most particularly at least 100° C.

Suitable fungicidal, herbicidal and insecticidal materials having a melting point of at least 55° C. and a solubility in water of not more than 600 ppm are listed below. In the tables, the names and identifiers are taken from the Pesticide Manual, 11^{th} edition.

Suitable fungicidal materials having a melting point of at least 55° C. and a solubility in water of not more than 600 ppm include the following:

Fungicides

| | | |
|---|---|---|
| amitrole (<ph4.2) | azaconazole (<ph3) | azoxystrobin |
| benalaxyl | benomyl | bitertanol |
| bromocunazole | captafol | captan |
| carbendazim | carboxin | chinomethionate |
| chlorothalonil | chlozolinate | copper oxychloride |
| cuprous oxide | cyproconazole | cyprodinil |
| dichlofluanid | dichlorophen | diclomezine |
| dicloran | diethofencarb | difenoconazole |
| dimethomorph | diniconazole | dinobuton |
| dithianon | dodemorph | epoxiconazole |
| ethirimol | famoxadone | fenarimol |
| fenbuconazole | fenfuram | fenpiclonil |
| fentin | ferbam | ferimzone |
| fluazinam | fludioxonil | fluoroimide |
| fluquinconazole | flusulfamide | flutolanil |
| flutriafol | folpet | fuberidazole |
| furalaxyl | hexachlorobenzene | hexaconazole |
| imibenconazole | ipconazole | iprodione |
| kresoxim-methyl | ktu 3616 | mancozeb |
| maneb | Mepanipyrim | mepronil |
| mercuric oxide | Mercurous chloride | metconazole |
| methasulfocarb | Metiram | myclobutanil |
| nickel bis | Nitrothal-isopropyl | nurimol |
| (dimethyldithiocarbamate) | | |
| ofurace | oxine-copper | penconazole |
| pencycuron | Pentachlorophenol | phthalide |
| probenazole | Promcymidone | propineb |
| pyributicarb | Pyrimethanil | quinoxyfen |
| quintozene | ssf-126 | sulphur |
| tebuconazole | Tecnazene | thiabendazole |
| thifluzamide | Thiophanate-methyl | thiram |
| tolclofos-methyl | Tolylfluanid | triadimefon |
| triadimenol | Triazoxide | triforine |
| triticonazole | Vinclozolin | zineb |
| ziram | | |

and strobilurin analogues i.e., a compound of the formula [1]

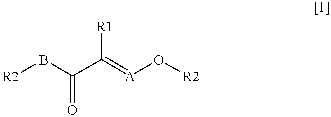

wherein R₁ is an aromatic or heteraromatic group,

R₂ is H, or C₁-C₁₀ alkyl

A is CH or N and

B is O or NH.

Particularly suitable strobilurin analogues include kresoxime methyl of formula and azoxystrobin.

Suitable insecticidal (or acaricidal) materials having a melting point of at least 55° C. and a solubility in water of not more than 600 ppm include the following:

Insectides/acaricides

| | | |
|---|---|---|
| Abamectin | Acrinathrin (i/a) | amitraz |
| | Azinphos-methyl | azocyclotin |
| Bensultap | Benzoximate (a) | bifenthrin (i/a) |
| Bromopropylate | Buprofezin | carbaryl |
| Carbofuran | Chinomethionat (a) | chlordane |
| chlorfenapyr (i/a) | Chlorfluazuron | clofentezine (a) |
| Coumaphos | Cryolite | cyfluthrin |
| beta-cyfluthrin | Cyhexatin (a) | cypermethrin |
| alpha-cypermethrin | beta-cypermethrin | theta-cypermethrin |
| d2341 (a) | Deltamethrin | diafenthiuron (i/a) |
| dicofol (a) | Dienochlor (a) | diflubenzuron |
| Dimethylvinphos | Dinobuton (a) | dpx-jw062/dpx-mp062 |
| Endosulfan (i/a) | Esfenvalerate | etoxazole (a) |
| Fenazaquin (i/a) | Fenbutatin oxide (a) | fenpyroximate (a) |
| fentin (a) | fipronil | flucycloxuron (i/a) |
| Flufenoxuron (i/a) | halofenozide | gamma-hch |
| Heptachlor | hexaflumuron | hexathiazox (a) |
| Hydromethylnon | isoprocarb | lufenuron (i/a) |
| Methiocarb (i/a) | methoxychlor | novaluron |
| Pentachlorophenol | phosmet | pymetrozine |
| Pyridaben | pyridaphenthion (i/a) | pyrimidifen (i/a) |
| Resmethrin | rh-2485 | rotenone |
| Spinosad | Sulfluramid | szi-121 (a) |
| Tebufenozide | tebufenpyrad (a) | Teflubenzuron |
| Tetrachlorvinphos | tetradifon (a) | Tetramethrin |
| Thiodicarb | tralomethrin | Triflumuron |
| Trimethacarb | xmc | Xylylcarb |

(I = insecticideA = acaricide (miticide)
PGR = plant growth regulator)

Suitable herbicidal materials having a melting point of at least 55° C. and a solubility in water of not more than 600 ppm include the following:

Herbicides

| | | |
|---|---|---|
| ac 94,377 (pgr) | Aclonifen | akh-7088 |
| ametryn | Amidosulfuron | asulam (<ph4.82) |
| Atrazine | Azafenidin | azimsulfuron |
| bay foe 5043 | Benazolin | benfluaralin |
| bensulfuron-methyl | Bentazone | benzofenap |
| Bifenox | Biphenyl | bromobutide |
| bromofenoxim | Bromoxynil | butralin |
| butroxydim | Butylate | cafenstrole |
| chlomethoxyfen | Chlobomuron | chloridazon |
| chlorimurom-ethyl | Chlorotoluron | chlorsulfuron |
| chlorthal-dimethyl | Cinosulfuron | clodinaop-propargyl |
| clomeprop | Cloransulam-methyl | cyanzine |
| cyclanilide (pgr) | Cyclosulfamuron | 2,4-d acid |
| daimuron | 2,4-db | desmedipham |
| desmetryn | Diclobenil | dichlorprop |
| dichlorprop-p | Diclofop-methyl | diflufenican |
| dimefuron | Dimethmetryn | dinitramine |
| dinoterb | Diphenamid | dithiopyr |
| Diuron | Ethalfluralin | ethametsulfuron- |
| | | methyl |
| ethofumesate | Ethoxysulfuron | ethychlozate (pgr) |
| etobenzanid | Fenozaprop-p-ethyl | flamprop-m- |
| | | isopropyl |
| flamprop-m-methyl | Flumetralin (pgr) | flumetsulam |
| flumiclorac-pentyl | Fluometuron | fluoroglycofen-ethyl |
| flupoxam | Flupyrsulfuron-methyl- | flurenol |
| | sodium | |
| fluridone | Flurochloridone | fluroxypyr |
| flurprimidol (pgr) | Flurtamone | fluthiacet-methyl |
| fomesafen | Forchlorfenuron (pgr) | halosulfuron-methyl |
| haloxyfop | Imazamox | imazaquin |
| imazosulfuron | Inabenfide (pgr) | indanofan |
| 4-indol-3-ylbutyric acid | Ioxynil | isoproturon |
| (pgr) | | |
| Isouron | Isoxaben | isoxaflutole |
| Lenacil | Linuron | mcpa |
| Mcpb | Mecoprop | mefenacet |
| mefluidide | Metazachlor | methabenzthiazuron |
| methasulfocarb (pgr) | Methyldymron | metobenzuron |
| metobromuron | Metosulam | metsulfuron-methyl |
| 2-(1-naphthyl)acetamide | 2-(1-naphthyl)acetic acid | (2-naphthoxy)- |
| (pgr) | (pgr) | aetic acid (pgr) |
| naproanilide | Napropamide | naptalm |
| neburon | Norflurazon | oryzalin |
| oxadiargyl | Oxadiazon | oxasulfuron |
| oxyfluorfen | Paclobutrazol (pgr) | pendimethalin |
| pentachlorophenol | Pentanochlor | pentoxazone |
| phenmedipham | n-phenylphthlamic acid | picloram |
| primisuluron-methyl | Prodiamine | prohexadione- |
| | | calcium (pgr) |
| prometon | Prometryn | propachlor |
| propanil | Propaquizafop | propazine |
| propham | Propyzamide | prosulfuron |
| pyraflufen-ethyl | Pyrazolynate | pyrazosulfuron-ethyl |
| pyributicarb | Pyriminobac-methyl | quinclorac |
| quinmerac | Quizalofop | quizalofop-p |
| rimsulfuron | Siduron | simazine |
| simetryn | Sulcotrione | sulfentrazone |
| sulfometuron-methyl | Sulfosulfuron | terbumeton |
| terbuthylazine | Terbutryn | thenylchlor |
| thiazopyr | Thidiazuron (pgr) | thifensulfuron- |
| | | methyl |
| tralkoxydim | Triasulfuron | tribenuron-methyl |
| triclopyr | Trietazine | trisulfuron-methyl |
| uniconazole | Florasulam | |

As water soluble pesticides, any pesticide that can be dissolved in water either alone or by derivatisation (such as by producing a salt by an appropriate neutralisation step) can be incorporated into either or both of the aqueous phases. These include paraquat (and its salts), diquat (and its salts), glyphosate as its water soluble salts, the auxin herbicides such as 2,4-D, clopyralid, MCPA, CMPP, triclopyr, fluroxypyr as their water soluble salts, the diphenyl ether herbicides exemplified by fomesafen as its water soluble salt, growth regulators such as chlormequat and mepiquat, fungicides such as dodine, guazatine, dodemorph, fenpropimorph and tridemorph as their water soluble salts.

Water soluble adjuvants such as urea, ammonium sulphate or other salts may also be incorporated into either or both of the aqueous phases. Likewise, water soluble surfactants may be incorporated into the aqueous phases.

Oil soluble pesticides may be incorporated into the oil phase of the multiple capsule. The pesticide should be soluble in the oil to a level appropriate for the desired formulation concentration. Clearly, this is variable dependent on both the pesticide and the oil chosen as solvent for the pesticide. Such selection is within the scope of one skilled in the art and the many pesticides suitable for dissolution in the oil phase can be identified in the Pesticide Manual, 11^{th} edition.

The present invention is particularly effective in providing an encapsulated water-in-oil-in-water multiple emulsion formulation of paraquat. In such a formulation, there is suitably up to 50% by weight paraquat salt (expressed as paraquat ion) in the internal aqueous phase, for example up to 35% by weight paraquat in the internal aqueous phase. The primary emulsion volume fraction (volume ratio of the internal aqueous phase in the dispersed organic phase) is suitably up to about 0.7, typically 0.65 and secondary emulsion volume (volume ratio of the total dispersed organic phase to the continuous aqueous phase) is suitably up to about 0.5, typically 0.45.

In a specific embodiment, it is known to include an emetic in paraquat compositions to reduce adverse effects in the event of accidental or deliberate ingestion. Compositions of the present invention wherein an emetic composition is contained in the continuous aqueous phase have the advantage that the emetic may take effect before significant exposure to the encapsulated paraquat contained within the internal aqueous phase has occurred.

The invention is illustrated by the following Examples in which all parts and percentages are by weight unless otherwise stated.

### EXAMPLE 1

1. Preparation of the Primary Emulsion

An aqueous solution of paraquat dichloride (54.02 Parts) containing 3.93 parts of paraquat expressed as paraquat ion) was emulsified using a high shear mixer into 38.3 parts of xylene in the presence of 7.64 parts of ATLOX 4912 emulsifier to form a water-in-oil emulsion. ATLOX is a trademark of UniQema. ALTOX 4912 is a polyester-ether-polyester ABA block copolymer; the A groups are poly(12-hydroxystearic acid) and group B is a poly(ethylene oxide) chain.

2. Preparation of the Water-in-oil-in-water Multiple Emulsion

To the water-in-oil emulsion prepared in stage 1 (5.7 parts) was added 0.61 parts of toluene diisocyanate (TDI). The monomer entered the organic phase. An aqueous solution was prepared containing 0.44 parts of diethylenetriamine (DETA), 0.018 parts sodium hydroxide, 0.19 parts sodium hydrogen carbonate, 2.9 parts sodium chloride in distilled water. This solution acts as a buffer for the system. The water-in-oil emulsion was emulsified into the outer aqueous phase using as a secondary emulsifier Gohshenol GL-05, Poly(vinyl alcohol), 94% min, mol wt 29,400, supplied by British Traders and Shippers. The proportions of components in the final water-in-oil-in-water multiple emulsion were as shown in Table 1.(Example 1).

A water-in-oil-in-water multiple emulsion was formed and microscopic examination showed that the oil phase droplets were encapsulated within a polymer wall. No encapsulation of the innermost phase water droplets had taken place within the encapsulated oil phase droplets.

TABLE 1
Overall proportions in the water-in-oil-in-water
multiple emulsion shown as % w/w

| Example No | 1 | 2 | 3 | 4 |
|---|---|---|---|---|
| Paraquat ion | 0.22 | 1.14 | 4.69 | 4.68 |
| ATLOX 4912 | 0.46 | 0.44 | 1.88 | 1.78 |
| Xylene | 5.2 | 5.1 | 12.85 | 8.93 |
| TDI | 0.61 | 0.61 | 0.61 | 1.41 |
| NaCl | 2.9 | 2.9 | 1.98 | — |
| GOHSENOL GL-05 | 0.75 | 0.75 | 0.45 | 1.14 |
| NaOH | 0.018 | 0.018 | 0.018 | — |
| NaHCO₃ | 0.19 | 0.19 | 0.19 | — |
| diethylenetriamine | 0.44 | 0.44 | 0.44 | 0.55 |
| Water | 89.2 | 88.4 | 62.81 | 66.2 |
| MgCl₂.6H₂O | — | — | 14.08 | 15.3 |

### EXAMPLE 2

The procedure of Example 1 was followed except that the proportions (% by weight) used in the primary emulsion were as follows:

| | |
|---|---|
| Paraquat ion | 19.10 |
| ATLOX 4912 | 7.24 |
| Xylene | 36.4 |
| Water | 37.26 |

A water-in-oil-in-water multiple emulsion was prepared using the general method of Example 1 to give proportions of the components shown in Table 1.

### EXAMPLES 3 and 4

The general procedure of Example 1 was followed to form a water-in-oil-in-water multiple emulsion wherein the proportions of the components were as shown in Table 1. The proportions used in the primary emulsion were as in Example 2. However, in this example the concentration of paraquat ion was increased above 4% w/w and it was found necessary (in contrast with the water-in-oil-in-water emulsions of Examples 1 and 2) to include magnesium chloride (as the hexahydrate) in the outer aqueous phase to balance the osmotic pressure of the paraquat dichloride in the inner aqueous phase.

### EXAMPLES 5, 6 and 7

This Example illustrates the formation of the polymer wall by the interaction of a mixture of PAPI (poly[methylene]poly[phenylisocyanate]) and toluene diisocyante with water. A primary emulsion was formed as in Example 2 using the proportions given below. The general procedure of Example 1 was followed with a mixture of PAPI and toluene diisocyante being added in place of toluene diisocyanate, except that after the formation of the water-in-oil-in-water emulsion the system was heated for 3 hours at 50° C. with stirring during which time a cross-linked internal phase wall was formed by reaction of the isocyanate mixture dissolved in the oil phase with water from the outer aqueous phase. A water-in-oil-in-water multiple emulsion was formed in which the proportions were as indicated below. In Example 7 REAX M100 (sodium lignosulphonate) was used as surfactant in place of GOHSENOL GL-05.

Primary Emulsion

| Example | 5 | 6/7 |
|---|---|---|
| Paraquat ion | 19.10 | 19.3 |
| ATLOX 4912 | 7.24 | 7.3 |
| Diesel oil | — | 35.0 |
| Xylene | 36.4 | — |
| Water | 37.26 | 38.4 |

Proportions in water-in-oil-in-water emulsion

| Example | 5 | 6 | 7 |
|---|---|---|---|
| Paraquat ion | 4.69 | 4.73 | 4.70 |
| ATLOX 4912 | 1.88 | 1.80 | 1.77 |
| Diesel oil | — | 8.61 | 8.54 |
| Xylene | 12.85 | — | — |
| TDI | 0.61 | 0.35 | 0.35 |
| PAPI | 0.61 | 1.41 | 1.40 |
| NaCl | 1.98 | — | — |
| GOHSENOL GL-05 | 0.45 | 1.14 | — |
| REAX 100 M | — | — | 1.36 |
| NaOH | 0.018 | — | — |
| NaHCO₃ | 0.19 | — | — |
| MgCl₂.6H₂O | 14.08 | 15.27 | 15.10 |
| Water | 62.16 | 66.7 | 68.52 |

### EXAMPLES 8, 9 and 10

The general procedure of Example 1 was followed except that SYNPERONIC NPE 1800 (a nonylphenol:polypropylene oxide:polyethyleneoxide surfactant supplied by UniQema) was used as the secondary emulsifier in place of GOHENSOL GL-05. The proportions used in the initial water-in-oil emulsion and the resultant water-in-oil-in-water multiple emulsion were as indicated below. In Example 8 and 10 diesel oil was used and in Example 9 xylene.

Primary Emulsion

| Example | 8/10 | 9 |
|---|---|---|
| Paraquat ion | 23.17 | 19.10 |
| ATLOX 4912 | 7.0 | 7.24 |
| Diesel oil | 21.75 | — |
| Xylene | — | 36.4 |
| Water | 40.08 | 37.26 |

Proportions in water-in-oil-in-water emulsion

| Example | 8 | 9 | 10 |
|---|---|---|---|
| Paraquat ion | 9.2 | 4.69 | 6.42 |
| ATLOX 4912 | 2.68 | 1.78 | 1.93 |
| Diesel oil | 8.35 | — | 6.0 |
| Xylene | — | 8.93 | — |
| TDI | 1.41 | 1.41 | 1.41 |
| SYNPERONIC | 3.8 | 3.8 | 3.8 |
| NPE 1800 | | | |
| DETA | 0.55 | 0.55 | 0.55 |
| MgCl₂.6H₂O | 17.6 | 14.7 | 15.05 |
| Water | 56.4 | 64.1 | 64.8 |

### EXAMPLES 11 and 12

This Example illustrates the formation of a water-in-oil-in-water emulsion in which the innermost aqueous phase and the intermediate oil phase are both encapsulated.

Stage 1

An encapsulated water-in-oil emulsion was formed by the interaction of TDI and DETA. An aqueous solution of paraquat dichloride (71.06 parts) containing 23.16 parts of paraquat expressed as paraquat ion and also containing 0.1 parts of DETA was emulsified using a high shear mixer into 21.56 parts diesel oil containing 6.99 parts Atlox 4912 and 0.27 parts toluene diisocyanate to form an encapsulated water in oil emulsion. The resultant proportions were as follows:

| | |
|---|---|
| Paraquat ion | 23.16 |
| ATLOX 4912 | 6.99 |
| Diesel oil | 21.56 |
| TDI | 0.27 |
| DETA | 0.1 |
| Water | 47.9 |

Stage 2

To the encapsulated water in oil emulsion prepared in Stage 1 (43.16) was added 1.49 parts toluene diisocyanate. The monomer entered the organic phase. An aqueous solution was prepared, containing 3.95 parts SYNPERONIC NPE1800, 16.4 parts magnesium chloride hexahydrate, 0.05 parts Kelsan M (polysaccharide swelling agent used to thicken the outer aqueous phase), 0.05 parts Proxel GXL (biocide to protect the polysaccharide against biodegradation), and 56.6. parts water. The encapsulated water in oil emulsion was emulsified into the aqueous solution, using a high speed homogeniser, then DETA (0.58 parts) was added (Example 11).

The pH was measured and found to be 8.5 at laboratory temperature; which is slightly higher than is desirable having regard to the chemical stability of paraquat. Therefore 0.05 parts of acetic acid was added to a sub-sample to give a pH of 5.5 (Example 12). The proportions in the resultant polyencapsulated multiple emulsion were as follows:

| Example | 11 | 12 |
|---|---|---|
| Paraquat ion | 9.25 | 9.25 |
| ATLOX 4912 | 2.79 | 2.79 |
| Diesel oil | 8.60 | 8.60 |
| TDI | 1.73 | 1.73 |
| SYNPERONIC NPE 1800 | 3.95 | 3.95 |
| DETA | 0.55 | 0.55 |
| MgCl₂.6H₂O | 16.4 | 16.4 |
| KELSAN M | 0.05 | 0.05 |
| PROXEL GXL | 0.05 | 0.05 |
| Acetic acid | — | 0.05 |
| Water | 56.50 | 56.45 |

### EXAMPLE 13

The following Example illustrates the use of fomesafen as active ingredient.

Stage 1

Fomesafen acid (9.42 parts) was slurried in water (30.48 parts) and DETA (1.58 parts) was added to form a clear solution of DETA: fomesafen salt. This solution was then emulsified into diesel oil (52.25 parts) containing ATLOX 4912 (4.65 parts) and TDI (1.62 parts) to form an encapsulated water in oil emulsion.

Stage 2

To the encapsulated w/o emulsion of fomesafen (Stage 1 above, 37.1 parts) was added 1.52 parts of toluene diisocyanate. The monomer entered the organic phase. An aqueous solution was prepared, containing 4.15 parts SYNPERONIC NPE 1800, 17.16 parts magnesium chloride hexahydrate, 0.05 parts PROXEL GXL, 0.05 parts KELSAN M, 0.59 parts DETA and 51.15 parts water. The encapsulated water in oil emulsion with the added TDI was then emulsified with a high speed mixer into the aqueous solution to give a doubly-encapsulated multiple emulsion. The proportions in the final emulsion were as follows:

| | |
|---|---|
| Fomesafen acid | 3.49 |
| DETA | 0.81 |
| ATLOX 4912 | 1.72 |
| Toluene diisocyanate | 2.05 |
| Diesel oil | 19.39 |
| SYNPERONIC NPE1800 | 4.13 |
| Magnesium chloride hexahydrate | 17.16 |
| KIELSAN M | 0.05 |
| PROXEL GXL | 0.05 |
| Water | 51.15 |

The water-in-oil emulsion of Stage 1 could alternatively be formed using the sodium salt of fomesafen. Thus for example fomesafen acid (21.08 parts) was slurried in distilled water (27.31 parts) and sodium hydroxide pellets (1.93 parts) were added. This results in a clear solution of fomesafen sodium salt. DETA (0.57 parts) and water (20 parts) were added to this solution and the solution was emulsified into diesel oil (20.7 parts) containing TDI (1.44 parts) and Atlox 4912 (6.97 parts) to form an encapsulated water in oil emulsion.

### EXAMPLE 14

Examples 14 and 15 illustrate the formation of a water in oil in water emulsion where the innermost aqueous phase is not encapsulated but the intermediate oil phase is encapsulated.

Stage 1

An aqueous solution of paraquat dichloride (70.3 parts) containing 22.05 parts of paraquat expressed as paraquat ion was emulsified using a high shear mixer into 23.76 parts solvesso 200 containing 7.7 parts Solsperse 17000 and 5 parts PAPI (poly[methylene] poly[phenylisocyanate]).

The Resultant Proportions were as Follows:

| | |
|---|---|
| Paraquat ion | 22.05 |
| Solsperse 17000 | 7.7 |
| Solvesso 200 | 23.76 |
| PAPI | 5.0 |
| Water | 41.49 |

Stage 2

An aqueous solution was prepared, containing Goshenol GL-03 (3.88 parts), Magnesium chloride (16.11 parts), Kelsan M (0.045 parts), Proxel GXL (0.045 parts) and water (56.2 parts). The water in oil emulsion containing PAPI from stage 1 was emulsified into this aqueous solution using a high speed mixer. The multiple emulsion thus formed was transformed into an encapsulated multiple emulsion (where only the intermediate oil droplet is encapsulated) by stirring and heating for three hours at 50° C. to give a singly encapsulated multiple emulsion. The proportions in the final emulsion were as follows:

| | |
|---|---|
| Paraquat ion | 9.08 |
| Solsperse 17000 | 2.91 |
| Solvesso 200 | 9.78 |
| PAPI | 1.89 |
| Gohshenol GL-03 | 3.88 |
| Magnesium chloride hexahydrate | 16.11 |
| Kelsan M | 0.045 |
| Proxel GXL | 0.045 |
| Water | 56.2 |

### EXAMPLE 15

Stage 1

The following composition was prepared in exactly the same way as for Stage 1 of Example 14, except the following proportions were used:

| | |
|---|---|
| Paraquat ion | 22.05 |
| Solsperse 17000 | 7.7 |
| Solvesso 200 | 21.76 |
| PAPI | 7.5 |
| Water | 40.99 |

Stage 2

The following sample was prepared in exactly the same way as for Stage 2 of Example 14, except that the following proportions were used:

| | |
|---|---|
| Paraquat ion | 9.08 |
| Solsperse 17000 | 2.91 |
| Solvesso 200 | 8.96 |
| PAPI | 2.82 |
| Gohshenol GL-03 | 3.88 |
| Magnesium chloride hexahydrate | 16.11 |
| Kelsan M | 0.045 |
| Proxel GXL | 0.045 |
| Water | 56.15 |

1. A water-in-oil-in-water multiple emulsion comprising a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets and at least one of (a) the inner dispersion of aqueous phase droplets and (b) the oil phase droplets being encapsulated within a polymer wall material.

2. A water-in-oil-in-water multiple emulsion according to claim 1 wherein the polymer wall material is the product of a reaction or interaction between two or more polymer precursor materials.

3. A water-in-oil-in-water multiple emulsion according to claim 2 wherein polymer wall material is the product of the reaction between an oil-soluble isocyanate and an water-soluble isocyanate-reactive polymer precursor wherein
i) the oil phase droplets are encapsulated within a polymer wall material formed by interfacial polymerisation of the oil-soluble isocyanate dissolved in the oil phase droplets and the isocyanate-reactive polymer precursor dissolved in the continuous aqueous phase or
ii) the inner aqueous phase droplets are encapsulated within a polymer wall material formed by interfacial polymerisation of a first isocyanate-reactive polymer precursor dissolved in the inner aqueous phase and the oil-soluble isocyanate dissolved in the oil phase droplets and the oil phase droplets are further encapsulated within a polymer wall material formed by interfacial polymerisation of a second isocyanate-reactive polymer precursor dissolved in the continuous aqueous phase and the oil-soluble isocyanate dissolved in the oil phase droplets.

4. A water-in-oil-in-water multiple emulsion according to claim 3 wherein the oil-soluble isocyanate is toluene diisocyanate or poly(methylene) poly(phenyl) isocyanate and the water-soluble isocyanate-reactive polymer precursor is diethylenetriamine, aminoethylpiperazine or tetraethylene pentamine.

5. A water-in-oil-in-water multiple emulsion according to claim 2 wherein both the inner aqueous phase droplets and the oil phase droplets are encapsulated within a polymer wall material which is the product of heating an oil-soluble isocyanate and an oil-soluble cross-linking agent in the presence of interfacial water.

6. A water-in-oil-in-water multiple emulsion according to claim 5 wherein the oil-soluble isocyanate is toluene diisocyanate and the oil-soluble cross-linking agent is [polymethylene] (polyphenylisocyanate).

7. A method of preparing a water-in-oil-in-water multiple emulsion comprising a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets and at least one of (a) the inner dispersion of aqueous phase droplets and (b) the oil phase droplets being encapsulated within a polymer wall material, which method comprises
i) forming a water-in-oil emulsion in which an aqueous solution or dispersion of the active material is emulsified in an oil phase containing a predominantly oil-soluble polymer precursor and emulsifying the water-in-oil emulsion into an aqueous phase containing a predominantly water-soluble polymer precursor such that interfacial polymerisation takes place to form a polymer wall encapsulating the dispersed oil droplets; or
ii) forming a water-in-oil emulsion in which an aqueous solution or dispersion of the active material is emulsified in an oil phase containing a first predominantly water-soluble polymer precursor, adding a predominantly oil-soluble polymer precursor whereby the polymer precursors undergo interfacial polymerisation to microencapsulate the dispersed aqueous droplets and thereafter emulsifying the resultant encapsulated water-in-oil emulsion into an aqueous phase; or
iii) forming a water-in-oil emulsion in which an aqueous solution or dispersion of the active material is emulsified in an oil phase containing a first predominantly water-soluble polymer precursor, adding a predominantly oil-soluble polymer precursor whereby the polymer precursors undergo interfacial polymerisation to microencapsulate the dispersed aqueous droplets and thereafter emulsifying the resultant encapsulated water-in-oil emulsion into an aqueous phase containing a second predominantly water-soluble polymer precursor, optionally with the addition of further oil-soluble polymer precursor, such that further interfacial polymerisation takes place to form a polymer wall encapsulating the dispersed oil droplets; or
iv) forming a water-in-oil-in-water emulsion comprising a continuous aqueous phase having dispersed therein oil phase droplets wherein each oil phase droplet contains an inner dispersion of aqueous phase droplets, a water-soluble or water-dispersible active material being dissolved or dispersed in the inner dispersion of aqueous phase droplets wherein the oil phase contains a first oil-soluble polymer precursor and a second oil-soluble polymer precursor which together form a polymer material when heated in the presence of water and heating the emulsion to form a polymer at the oil-water interfaces.

8. A method according to claim 7 wherein the oil-soluble polymer is an isocyanate.

9. A water-in-oil-in-water emulsion according to any of claims 1 to 6 or a method according to any of claims 7 and 8 wherein a water-soluble electrolyte is added to the continuous aqueous phase to balance the osmotic potential between the inner dispersed aqueous phase and the outer continuous aqueous phase.

10. A water-in-oil-in-water emulsion according to any of claims 1 to 6 and 9 or a method according to any of claims 7, 8 and 9 wherein the active material is paraquat, diquat, glyphosate, 2,4-D, clopyralid, MCPA, CMPP, triclopyr, fluroxypyr as their water soluble salts, fomesafen and its water soluble salts , chlormequat, mepiquat, dodine, guazatine, dodemorph, fenpropimorph and tridemorph and where appropriate water soluble salts and mixtures thereof.

11. A water-in-oil-in-water emulsion according to any of claims 1 to 6 and 9 or 10 or a method according to any of claims 7, 8 and 9 or 10 wherein a second water-soluble or water-dispersible active material is dissolved or dispersed in the continuous aqueous phase.

12. A water-in-oil-in-water emulsion according to any of claims 1 to 6 and 9 to 11 or a method according to any of claims 7, 8 and 9 to 11 wherein the oil forming the oil phase is a mineral oil, paraffin oil, diesel oil, vegetable oil or an esterified vegetable oil.

13. A method according to any of claims 7, 8 and 9 to 12 wherein the initial water-in-oil emulsion is formed in the presence of a first surfactant system and the water-in-oil emulsion thus formed is emulsified into a continuous aqueous phase using a second surfactant system.
